(19) United States
(12) Patent Application Publication
(10) Pub. No.: US 2005/0210401 A1
(43) Pub. Date: Sep. 22, 2005

(54) Method and system for centralized copy/paste functionality

(75) Inventors: Pekka Ketola, Tampere (FI); Jussi Mantere, Espoo (FI); Juha Karttunen, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/805,678

(22) Filed: Mar. 18, 2004

(51) Int. Cl. G06F 3/00

(52) U.S. Cl. 715/770; 715/769

(57) ABSTRACT

This invention relates to a method for transferring data from a source application to a target application. From the application an operation is traced, from which operation at least one item is extracted. The item is saved in a trace log file, from which it can be selected and transferred into said target application. The operation can be e.g. incoming or outgoing call, where the item is a phone number or a contact card. The invention relates also to a device, to a system and to computer program product.

### FIELD OF THE INVENTION

The current invention relates to personal computing and particularly to a data transfer, i.e. copy-paste functionality, between applications.

### BACKGROUND OF THE INVENTION

In personal computing, the basic operation of copy-paste and cut-paste functionalities have been quite unchanged for a couple of decades. These functionalities have been utilized especially in graphical user interfaces, but also in certain text-based interfaces. They are very useful tools in applications for they operate as a data transfer method between locations within one application program or between different application programs.

Copy-paste and cut-paste functionalities can be implemented variously. The basic operation, which is known from Microsoft Windows® environment follows steps, wherein part of a text, an image or a similar item is chosen and “copied” or “cut”. Due to the copy/cut operation, the chosen item is saved into a temporal memory, wherefrom that item may be transferred into new location by a paste operation. The main difference between copy and cut functionality is that whereas cut command deletes the item from the source application, the copy command leaves it at its original place. Above-mentioned steps can be carried out with, for example, a key combination, wherein “arrow” and “shift” keys are usually used for selecting items, and for copy operation “control” and “c” and for cut operation “control” and “x” keys are pressed together. A target application program can be chosen by holding “alt” key down and selecting the application program with a tabulator and activating it by releasing the “alt” key. When the target application program is activated the user needs to choose a place where the item is pasted. After this the item can be pasted in both operations by pressing “control” and “v” keys together.

Copy/cut-pasting can also be done with a mouse, with which the user can select the area or the item to be transferred into other location. The wanted word or paragraph is “painted” (selected, highlighted) or the wanted item is activated after which the user can select the “copy” or “cut” operation from a menu (from the application program or from the menu of the mouse), wherein the item is saved into the temporal memory. After the user has selected a location where the item is to be transferred, the user further chooses the “paste” function from the menu, after which the item is transferred to desired location. In some computing systems data transfer can also be done by “drag and drop” operation, which functionality varies depending on the application programs. If the source and target applications belongs to same application family (e.g. Microsoft Office) the drag-and-drop “cuts” the item out, if not it transfers a copy of the selected item (and leaves the original) or presents a menu where the pasting by copy-function or pasting by cut-function can be selected. In addition the drag-and-drop operation is more usable if both the source application program as well as the target application program are in the view of the user.

In some application programs a tool called a clipboard tool can be utilized for storing copied items and accessing them for selecting and pasting purposes. After one or several copy-commands, the user can enter the clipboard tool and choose one item or all to be pasted. Only the first or all the items can be pasted depending on the chosen command “paste” or “paste all”. In addition, the items can be deleted from the clipboard tool if they are not needed. The clipboard tool is usually shared only between a few program applications.

As said, copy pasting of these kinds are utilized when the copied item is part of a text, part of an image or a whole image or a file. Generally the source application and the target application support each other's media types. In some cases the target application can also convert the media type of the source application to the supported media type (e.g. when pasting text content into image editing program the text is converted to image). If the target application program does not know how to handle the pasted item from the source application program, the item can be shown as an icon of said source application program. The target application in responsible for determining what to do with the item being pasted. E.g., if a text application program cannot handle images, the image may not pasted at all even if it contained text. Similarly, if the copied item contains formatted text, such as Rich Text format, the formats will be removed before pasting the text to e.g. a plain text document.

Above-mentioned implementations are mainly utilized in personal computers. The evolution of mobile computing brings new functionalities and new application programs also to mobile devices. Hence, the need for sharing information between those applications increases.

In some advanced mobile devices similar copy-paste functionality can be found, which allows the user to select (with a stylus or keys) parts of the text in certain application program, copy it into memory and afterwards paste it elsewhere. Certain advanced devices, like applicants Series 60™ type, comprise one kind of a clipboard tool, which can be utilized for copy-pasting. But also this tool can only be utilized between only some application. The basic copy-paste methods are addressed basically to well-defined item types, such as text, image, URL or a file as a whole or partially.

As can be noticed from the description above, current advanced devices do not have an explicit way to transfer data between locations and between application programs by utilizing a clipboard tool. The clipboard tool can be utilized only in certain application programs and for certain type of contents, such as textual and images.

Thus, what is needed is an improved method for transferring data from one location into another, that is an improved method for copy-paste-functionality especially in mobile devices. This invention addresses such a need.

### SUMMARY OF THE INVENTION

This invention relates to an automatic trace-paste method in personal computing devices, especially mobile computing devices.

The aim of the current invention is to provide easier and more usable copy-paste function e.g. for computing devices, wherein user inputs can be reduced. The copy-pasting according to the invention is automatic, but it is also made possible to operate manually.

Another aim of the current invention is to make copy-paste function available for all relevant media types, wherein the functionality is not limited only to some as in related art.

Yet another aim of the current invention is to provide a tool, which gathers the copied items into one place independently of their media types, where they can further be selected and pasted from.

For doing this, the method according to the invention comprises steps for tracing an item from an operation in one application and recording it into a sequential file where the item is selected by another application to be transferred into said another application, said method being addressed to any kind of media type. In other words one kind of a log file is upheld according to the invention, where the operations are stored sequentially. Information of this trace log is used similar to the clipboard-metaphor. For better usability of said file, the operations are divided depending on their media types.

According to the invention, items of the latest operation—being performed by the device with or without the user action—are automatically stored into the trace log. Items can then be used in any relevant application program. Some examples of such operation is a phone call where a phone number can be an item; a camera shot, where an image can be an item; a site downloaded from the network, where the site and its URL can be items. These operations are naturally just examples; a man skilled in the art will become aware the other possibilities of the invention,

Due to the automatic storing the user is freed from inputting commands for copying these operations. However, it is still possible to copy items manually into the trace log of the invention.

Thanks to the invention, the last operation data is nearly always available (sometimes e.g. large processes as well as low memory can cause lacking). In addition, the last operations are available in different categories. The user has access to recent information like recent message content, recent URL, recent contact information, the highest score etc. which all locate centralized in the same place.

Another advantage of the invention is the possibility to share any kind of data between applications, programs and even between users. Due to the automatic operation and reduced copy-paste-actions the efficiency of the users increases.

The method provides also an effective way for composing a MMS-message (Multimedia Messaging Service) from the latest operations of the user. This kind of message composing requires very few user inputs. The user can easily, for example, transfer the latest image downloaded from the internet into the message without manual saving of the item. It should be noticed that, thanks to the invention, the media type of the transferred data can be different from the ones the target application program can handle.

Because the solution of the invention is not dependent of media types, the invention can be applied to any existent or upcoming media types.

### BRIEF DESCRIPTION OF THE DRAWINGS

A better understanding of the invention may be obtained from the following considerations taken in conjunction with accompanying drawings, which are not meant to restrict the scope of the invention in any way.

FIG. 1a-b illustrate examples of a device utilizing the invention,

FIG. 2 illustrates an embodiment of the method according to the invention for saving an operation,

FIG. 3 illustrates an embodiment of the method according to the invention for pasting the operation

FIG. 4a-4b illustrate in a very simplified manner examples of a views of the tracing application program, and

FIG. 5 illustrates a relationship of the source application, tracing application and the target application.

### DETAILED DESCRIPTION OF THE INVENTION

Before the detailed description of the invention, the applicant wishes to define few terms which are used in the description. “An operation” means in the description something operating and operable in a computing device. Operation can be receiving an email/a call/a message, downloading an item from the network, photographing, marking calendar etc.—in other words, any action that is happening in the device by the user or by the device. “An item” refers to the operation and is the determinant part of the operation that can be copied/transferred. The item can be a content of the operation or a property of the operation. If the operation is an incoming call, then the item can be a contact information such as a phone number, or a contact card. On the other hand, if the operation is an incoming multimedia message, then items can be message content components (text, image etc.) or contact information. A term “media type” does not necessarily—but can—mean the well-known MIME-types. Media type, which is discussed in more detailed afterwards, defines category for the operation in general. “Transfer function” refers to the method according to the invention which resembles the known copy-paste function. Transfer function comprises at least the steps for copying (tracing, recording) and pasting. “An application” refers here to a location where the item is and, then again, where the item is transferred. An application locates within “an application program.” The method according to the invention can be implemented between applications in same or in different application programs. Also, what should be noticed, that in certain situations the application can be arranged to save the item to the memory means of the device, whereupon the specific application program need not to launched.

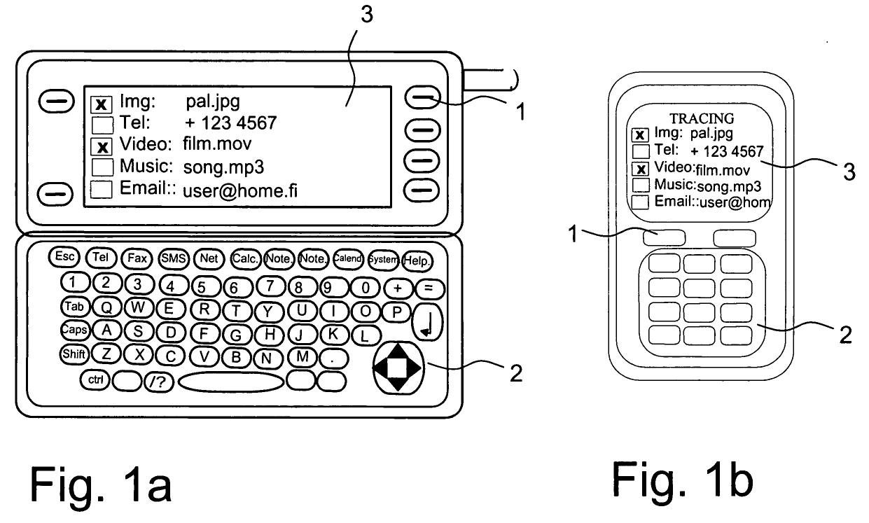

The method according to the invention is mainly addressed to portable devices (see FIGS. 1a and 1b) such as mobile phones, smart phones, PDA devices and similar advanced terminals. Devices comprising a Series 60™ type of user interface (provided by the applicant) can be used as examples. However, after reading this description it will become evident to the reader that this invention is not solely limited to said devices, but can be utilized in any computing environment dealing with similar functionalities, e.g. in personal computers. But as said, the greatest need for the invention can be found in such portable devices which usually have relatively low memory and limited processing capability. In addition, such devices usually have limited number of input keys 2 as well as a relatively small display 3. Because of those features, such devices need new methods for different tasks for the sake of a good usability.

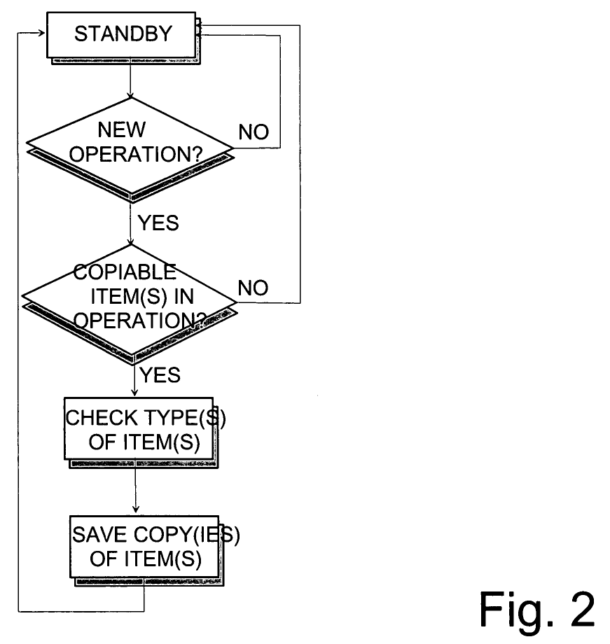

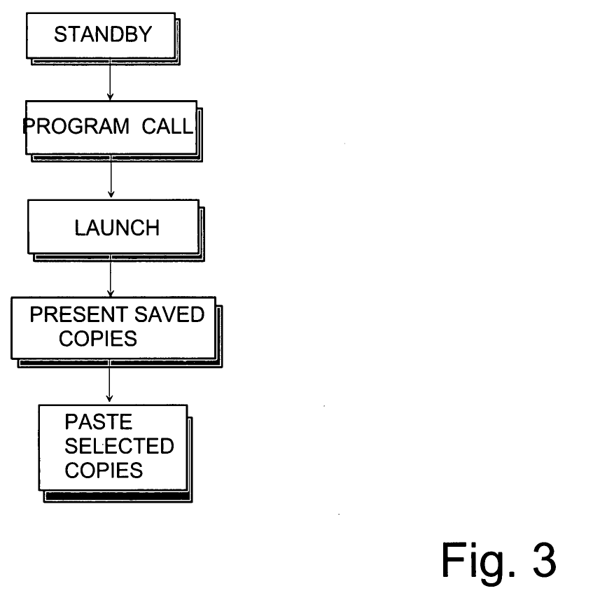

The method according to the invention can be carried out by an independent software application program, which is further referred by a term “tracing application”. This tracing application is an advanced and centralized trace log which stores a record of an item of the last operation done by the user with the device or by the device itself. The operation can be a single operation or a set of operations resulting from certain macro or script. It should be also noticed, that the user can bind two or more operations together, and used it for the copiable operation. The copy can be afterwards used in some other situation, e.g. in different application programs or in a different location. The method works automatically meaning that after the operation (phone call, messaging, imaging, etc.) the operation item (e.g. phone number, message content, an image) is saved into the tracing application. An example of automatic saving is presented in a flowchart in FIG. 2. In addition an example of pasting operation is presented in a flowchart in FIG. 3.

The tracing application can also be used semi-automatically or manually with a certain function key 1, e.g., an edit key (see FIGS. 1a-1b). The user can choose text areas or single items and copy them into the tracing application. The tracing application comprises the item itself, but for the sake of less memory consumption the tracing application can comprise a link to said item. By pressing and holding the function key 1 down, a cursor is provided to the user with which the user can move in the source application program. When the cursor is moved above the item, the item is activated or when the cursor is moved above a text, the text area can be highlighted. The copying to the tracing application can then be done by some other function key. This process resembles the copying methods according to related art, but it should be kept in mind, that all the copied items, irrespective of their media types, are collected to the same log file.

It should be noticed that for preventing overwriting of items due to the automatic storing and manual copying, the tracing application can also have its own class for manually copied items. If several items of different media types (e.g. video, image, text) are “painted”, the class for manually copied items can be divided for those types.

If in any case the copying cannot be performed, the copied item can be pasted in a known way.

The tracing application according to the invention is launched separately or by a function call performed by another application program. The call can be substantially any kind of access command, e.g. a key combination or a menu selection (e.g. a paste). The calling application program can be located within the same device as the tracing application or in a different device. In case the application programs are located in different devices, the function call can be delivered via a communication network. The selection between an application related storage file (such as image gallery) and the tracing application according to the invention can be done e.g. by opening the tracing application by command “paste” and opening the application related storage file (e.g. image gallery) by command “insert” (e.g. insert image).

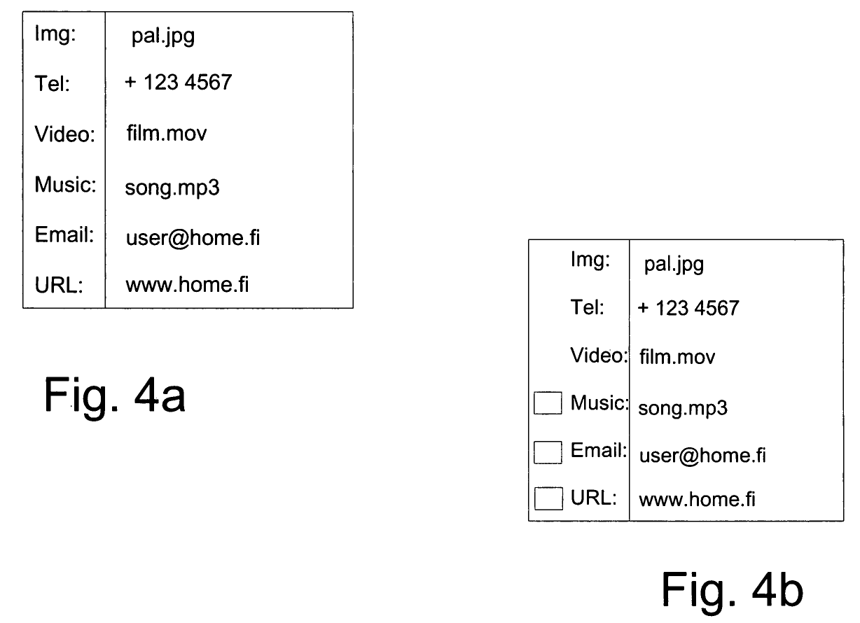

After launching the tracing application, a list comprising the saved items (operations) is presented to the user. The copied items can be viewed or deleted or selected to be transferred, edited, sent etc. from the list to be accessed by the target application. The operation items can be shown to the user as icons or as text or as a mixture of them (FIG. 4a). For example for composing a message one or many items can be selected from the list and attached to the message application program. For choosing several items, e.g. a check-box-feature can be utilized (see FIG. 4b). This feature is advantageous e.g. in multimedia messaging where several multimedia items can be easily chosen from one list.

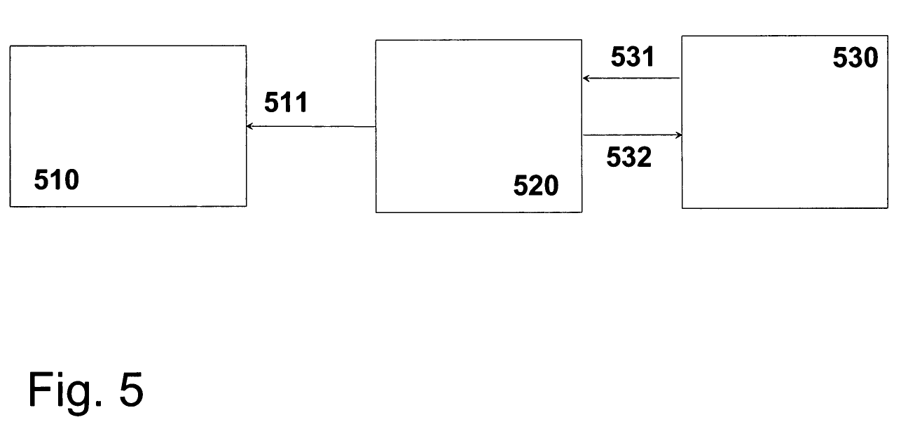

One example of the invention is presented in FIG. 5, where the relationships of the application programs are shown. When an operation is detected an item is traced 511 from the source application program 510 by the tracing application program 520. If the item is desired to be pasted, it is acquired from the tracing application program 520 by a function call 531 from the target application 530 or by launching the tracing application program 520 separately. In both cases the item is transferred (pasted) 532 into the target application.

The solution according to the invention is independent on application program types. Hence, the source and target application programs can be different, e.g. belong to different program families or supporting different media types. In addition, the source and target application program can locate in different devices. The pasting between devices can be implemented in different ways. For example, the whole trace log file can be transferred to the other device or shared with the other device. Saved items can also be transferred individually to the application program of the other device, or to the trace log file of the tracing application program of the other device. After this the user of the other device can take the item and paste it elsewhere in the device.

As mentioned earlier, the tracing application is not limited to media types. Table 1 presents a few examples of the media types that are handled by the invention.

TABLE 1
Media types supported by the invention

| Media types | Appearing in |
|---|---|
| Text | Message text |
| | Note pad |
| | Text from a web site |
| Image | Image gallery |
| | Camera |
| | Camera shot |
| Video | Video gallery |
| | Streaming |
| Audio | Voice recorder |
| | Voice identifier |
| URL | WAP |
| | WWW |
| | Streaming |
| Phonebook entry | Phone number |
| | Email-address |
| | Fax number |
| | Contact care |
| Music | File |
| | Play list |
| | Radio channel |
| calendar event | Calendar |
| Wallet | |
| error messages | |

The next table 2 presents examples of operations that can be traced from different functionalities.

TABLE 2
Functionalities and traced operations

| Functionalities | Traced operations |
|---|---|
| Messaging | Incoming - outgoing - viewing - |
| | SRRF - IR |
| Calling | Received - dialled - missed |
| Imaging | Screen capture - photographing - |
| | SRRF |
| Browsing | |
| Using application | Calendar event - contact |
| programs | information - music |
| Selecting | Copy |

In summary, operations that relate to receiving, sending, downloading, creating or deleting can at least be recorded. For example items can be received through short range radio frequency (SSRF, e.g. Bluetooth™) and traced by the tracing application. The tracing application can also be launched by a trigger from a protocol, e.g. OBEX (OBject Exchange). When looking the examples presented in the tables above, it should be kept in mind, that the examples are not the only copiable operations. This is important, because the idea of the log file is that it can be set to store any operation or process happening in the device. And due to this feature, this invention can be applied in current application programs of the device but also in future application programs.

When viewing the tracing application the user can select one or many items being the whole or partial data e.g. of a message, a web form, contacts, personal information manager (PIM) being pasted or inserted to a certain target. As an example of the contact information the “whole data” can be the contact card and the partial data can be part of information, e.g. a name or a phone number.

The main idea of the invention can be utilized in various different environments where copy-paste-function is needed. The use of the tracing application is optional with other known methods. The foregoing detailed description is provided for clarity of understanding only, and the details are not necessarily limitations with respect to the claims herein.

1. A method for transferring data from a source application to a target application, the method comprising steps for
tracing an operation relating to the source application,
extracting at least one item from said operation,
recording said item into a file,
wherein said file is called by the target application for selecting and pasting the item to said target application.

2. The method according to claim 1, wherein the item is selected from the file by means of a clipboard.

3. The method according to claim 1, wherein more than one operations are traced and recorded.

4. The method according to claim 1, wherein said operation is traced automatically.

5. The method according to claim 1, wherein the file is a log file.

6. The method according to claim 1, wherein at least one of the following operations: handling, receiving, sending, downloading, creating, deleting, is traced.

7. The method according to claim 6, wherein said item is a content of the operation or a property of the operation.

8. The method according to claim 1, wherein the source application and the target application are located within one application program.

9. The method according to claim 1, wherein the source application and the target application are located in different application programs.

10. The method according to claim 1, wherein the source application and the target application are located in different devices.

11. The method according to claim 1, wherein said file is shared between application programs of a computing device.

12. The method according to claim 1, wherein a type of the item is identified.

13. The method according to claim 12, wherein said type belongs to one of the following groups: image, audio, video, text, URL, phonebook entry, music, calendar event, wallet and error message.

14. The method according to claim 12, wherein said type is used for classifying the item.

15. A device for computing, said device comprising a source application, a target application and
tracing means for tracing an operation relating to the source application,
extracting means for extracting at least one item from said operation,
a file for storing said item,
said file is arranged to receive an access command from the target application and to present items from the file.

16. The device according to claim 15, wherein one or many item from the file is selected to be accessed by the target application.

17. The device according to claim 15, wherein said tracing means are configured to operate automatically.

18. The device according to claim 15, wherein the file is a log file.

19. The device according to claim 15 comprising also means for at least one of the following operations: messaging, calling, imaging, browsing, using application programs and selecting.

20. The device according to claim 19, wherein said extracting means are configured to extract the item from a content of the operation or from a property of the operation.

21. The device according to claim 15, wherein the source application and the target application are located within one application program.

22. The device according to claim 15, wherein the source application and the target application are located in different application programs.

23. The device according to claim 15, comprising means for exchanging data with another device.

24. The device according to claim 15, further comprising means for identifying a type of the item.

25. The device according to claim 24, further comprising means for classifying the item based on the its type.

26. The device according to claim 15, wherein said operation is implemented without user action.

27. The device according to claim 15, further comprising means for manual copying.

28. The device according to claim 15, further comprising means for mobile communication.

29. A system for implementing the method of claim 1.

30. A computer program product, comprising memory means and a computer program comprising instructions for
tracing an operation relating to one application,
extracting at least one item from said operation,
recording said item into a file,
said file being called by another application for selecting the item to be pasted.
